(19) United States
(12) Patent Application Publication
(10) Pub. No.: US 2025/0117491 A1
(43) Pub. Date: Apr. 10, 2025

(54) SYSTEMS AND METHODS FOR RESIDUAL RISK ASSESSMENT IN INFORMATION TECHNOLOGY MANAGEMENT

(71) Applicant: Kyndryl, Inc., New York, NY (US)

(72) Inventors: Pawel Jasionowski, Wroclaw (PL); Dan S. Riley, Wake Forest, NC (US); Jeffrey Biegel, Saugerties, NY (US); Priya Chahal, Singapore (SG); Melissa Melancon, Loveland, CO (US); John Chidester, Sautee Nacoochee, GA (US); Jalen Hickman, Louisville, KY (US)

(21) Appl. No.: 18/378,240

(22) Filed: Oct. 10, 2023

(51) Int. Cl. G06F 21/57; G06F 11/07; G06Q 10/0635

(52) U.S. Cl. CPC G06F 21/577; G06F 11/0793; G06Q 10/0635

(57) ABSTRACT

A computer-implemented method including: obtaining, by a computing device, a plurality of risk events; mapping, by the computing device, treatment actions to each of the plurality of the risk events; determining, by the computing device, an impact of the treatment actions on each of the plurality of the risk events; determining, by the computing device, a probability of implementation of the treatment actions; calculating, by the computing device, how the treatment actions affect other risk factors based on the determining steps; and providing, by the computing device, a recommendation of optimal risk mitigation based on how the first treatment actions affect the other risk events.

### BACKGROUND

Aspects of the present invention relate generally to risk assessment and, more particularly, to systems and methods for residual risk assessment in information technology management.

Information Technology (IT) risk management is the application of risk management methods to manage Information Technology threats. More specifically, Information Technology risk management involves procedures, policies, and tools to identify and assess potential threats and vulnerabilities in Information Technology infrastructure.

In Information Technology management risk assessment, when the risks are identified, an organization nominates treatment actions to mitigate such risks. Typically, when the treatment action implementation is completed, the organization will consider the risk as being mitigated. However, such mitigation can impact risk assessment accuracy. For example, implementing treatment actions on one risk could cause an impact on other risk areas.

### SUMMARY

In a first aspect of the invention, there is a computer-implemented method including: obtaining, by a computing device, a plurality of risk events; mapping, by the computing device, treatment actions to each of the plurality of the risk events; determining, by the computing device, an impact of the treatment actions on each of the plurality of the risk events; determining, by the computing device, a probability of implementation of the treatment actions; calculating, by the computing device, how the treatment actions affect other risk factors based on the determining steps; and providing, by the computing device, a recommendation of optimal risk mitigation based on how the first treatment actions affect the other risk events.

In another aspect of the invention, there is a computer program product including one or more computer readable storage media having program instructions collectively stored on the one or more computer readable storage media. The program instructions are executable to: obtain a set of defined treatment actions; associate the set of defined treatment actions with a plurality of risk events; determine weights or risks vector (wor) comprising, for each risk event, a different impact on a final risk; determine, for each risk event, a probability of implementation of the treatment action; determine a factorization of an additional equivalence relation on a set risks by grouping risks into risk event categories; calculate a residual risk assessment utilizing the factorization of the additional equivalence relation, the residual risk assessment considers all possible scenarios of treatment actions subsequent to an implementation on the risk events; and generate a recommendation of a best scenario for optimal risk mitigation based on the residual risk assessment.

In another aspect of the invention, there is system including a processor, a computer readable memory, one or more computer readable storage media, and program instructions collectively stored on the one or more computer readable storage media. The program instructions are executable to: obtain, by a computing device, a plurality of risk events; map, by the computing device, treatment actions to each of the plurality of the risk events; determine, by the computing device, an impact of the treatment actions on each of the plurality of the risk events; determine, by the computing device, a probability of implementation of the treatment actions; calculate, by the computing device, how a first treatment action on a first risk of the plurality of risk events affects other risk factors; and provide, by the computing device, a recommendation of optimal risk mitigation based on how the first treatment action on the first risk of the plurality of risk events affects the other risk events.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a flowchart of an exemplary method in accordance with aspects of the invention.

### DETAILED DESCRIPTION

Aspects of the present invention relate generally to risk assessment and, more particularly, to systems and methods for residual risk assessment in information technology management. According to aspects of the invention, the systems and methods map a set of risk events with a set of treatment actions and considers a residual function which supports the decision-making process. To achieve this mapping, the systems and methods identify an association function among risk classes and treatment action classes. In embodiments, the associations can be a mapping which answers the question “what is the final risk assessment after implementing treatment actions?” In this way, the systems and methods determine whether the final risk assessment is lower or higher than the original risk when considering different risk dimensions, e.g., probability and impact in the targeted risk and residual class of such risk. For example, the systems and methods will determine whether there is a change in risk level for other risks when the risk which treatment action is assigned. Accordingly, by implementing aspects of the present invention, it is now possible to optimize treatment of risk in terms of both cost effectiveness and probability of success, in addition to enabling lifecycle management of treatment plans, facilitating their completion and measuring their impact on service delivery.

In more specific embodiments, the systems and methods provide a technical solution to the problem of risk mitigation and how a treatment action may affect other risks, e.g., exacerbate other risk events. In implementation, the systems and methods automatically create a treatment action plan based on defined treatment actions, in addition to enabling continual service improvement by measuring the impact of the treatment action plan and minimizing a level of uncertainty and residual risk assessment error. This is accomplished by (i) using a residual function to create an optimal plan of improvement of risk reduction, (ii) using a factorization of a set of risks to determine and mitigate the treatment action's impact on risk uncertainty, and (iii) measuring the impact of every implemented plan and feeding the learning back into the system to minimize residual risk assessment error.

By way of example, the systems and methods described herein combine a mapping of treatment actions on risk events, provide a probability of implementation of treatment actions and risk event classification, and create a residual function to connect different aspects of treatment action implementation on risk. The residual function is used to create an optimal plan of improvement of risk reduction. Also, the systems and methods provide a factorization of a set of risks to determine and mitigate the treatment action's impact on risk uncertainty. Accordingly, the systems and methods configure an optimal risk's treatment action to mitigate a final risk assessment, enabling continual service improvement by measuring the impact of a created treatment action plan on service delivery to manage treatment action plans through their lifecycle.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (Saas): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

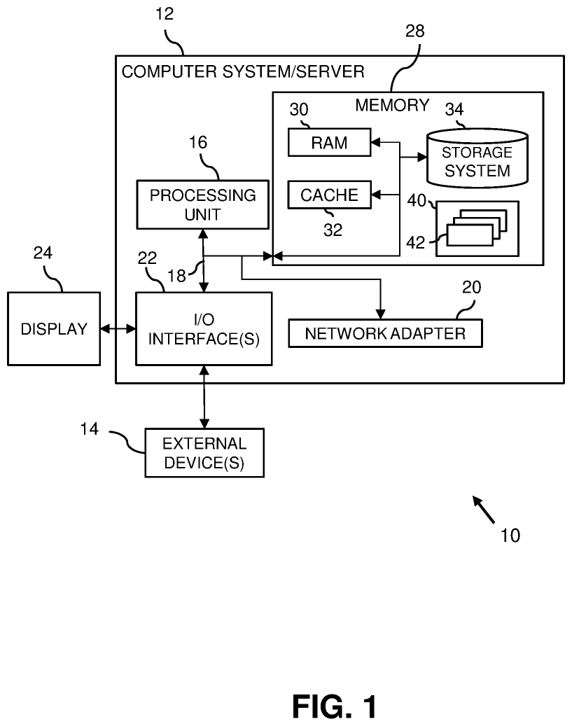

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

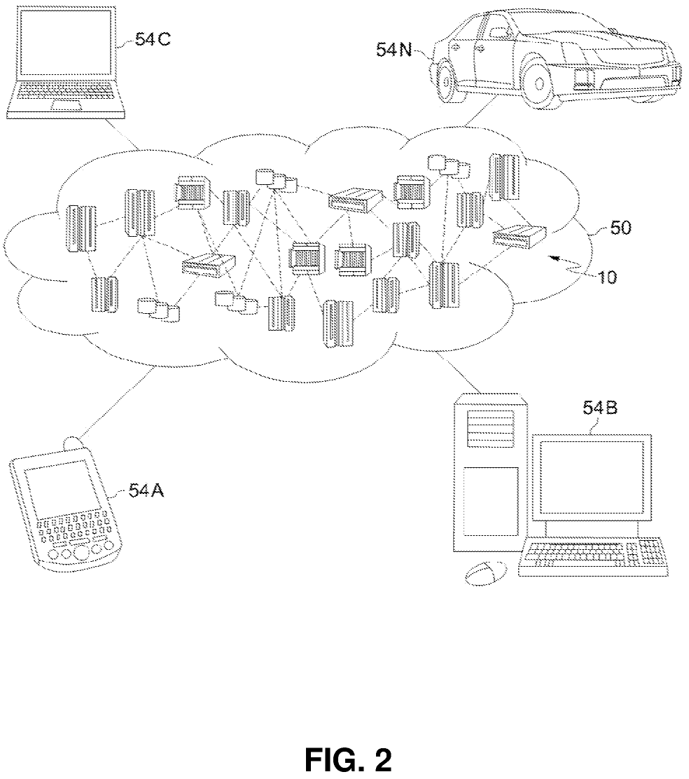

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

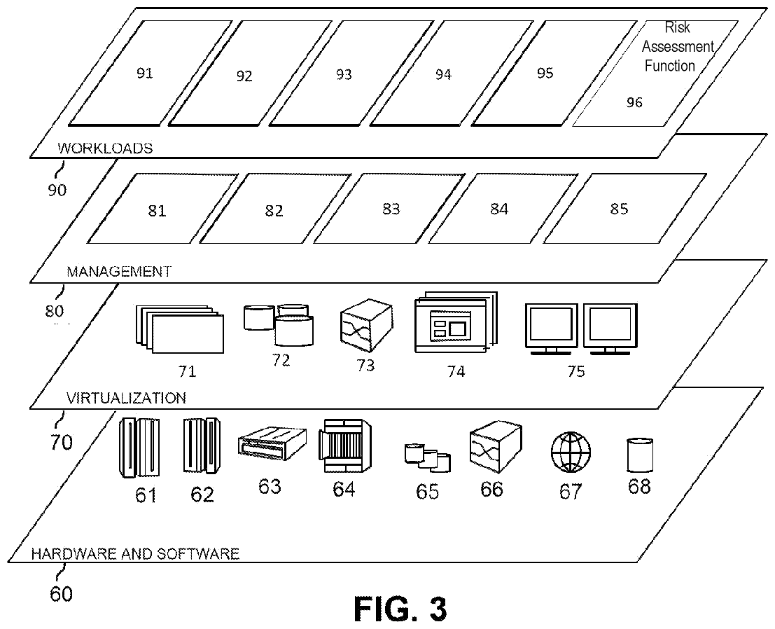

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and risk assessment function 96.

Implementations of the invention may include a computer system/server 12 of FIG. 1 in which one or more of the program modules 42 are configured to perform (or cause the computer system/server 12 to perform) one of more functions of the risk assessment function 96 of FIG. 3. For example, the one or more of the program modules 42 are configured to calculate a final risk in a risk assessment process by corroborating assessed risks, treatment actions, and residual classes of risks and their treatment actions. For example, the risk assessment function 96 determines the impact of a treatment action assigned to a risk on other risks from a considered risk set. In embodiments, the impact is described by an impact of treatment action on each dimension of each risk and a matrix defined as Implementing Treatment Action on Risk (ITAR) as further described herein.

In aspects of the present invention, by using the risk assessment function 96 of FIG. 3, each risk event can be considered as having a different impact on a final business risk as expressed by vector of risks weights (wor). Moreover, each treatment action can be considered as having different probability of implementation by the business and is determined by the business based on their account policy as expressed in by a vector representing ta implementation probability (poi). A factorization of a set of risks by a defined relation will mitigate uncertainty levels included into values defined by business observations of risks importance. Based on created items, the residual risk assessment considers all possible scenarios of treatment actions subsequent to the implementation on the risk events set and recommends a subset of treatment actions with the best final risk mitigation. And a continual service improvement can be provided by measuring the impact of created treatment action plan on delivery, i.e., if the risk materialized in delivery upon implementation of the proposed set of treatment actions and is feeding back the system with observations.

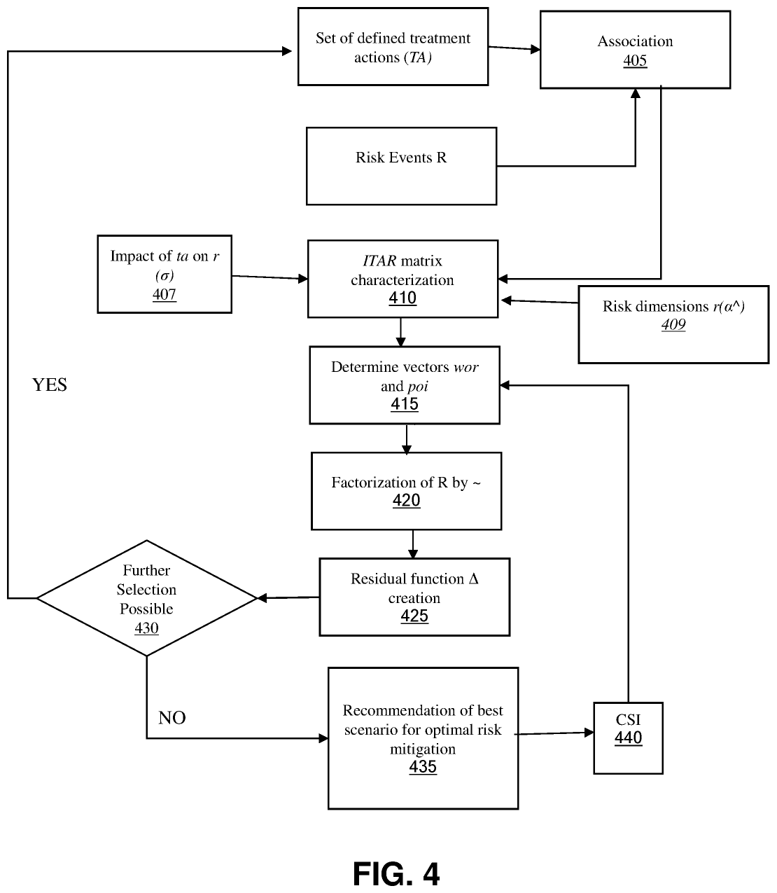

FIG. 4 shows a flowchart of an exemplary method in accordance with aspects of the present invention. Steps of the method may be carried out in the environment of FIG. 4 and are described with reference to elements depicted in FIG. 4. Table 1 in the “Use Case” provides a list of risk topics and levels of risk associated with possible answers, which can be implemented in the flow of FIG. 4. Table 2 in the “Use Case” provides a set of risks topics along with nominated treatment actions, which can be implemented in the flow of FIG. 4.

At step 405, an association is made between a set of defined treatment actions (TA) and risk events (R). (Tables 1 and 2 below show risk topics and treatment actions.) In embodiments, R={r_1, r_2, . . . , r_n}, which is representative of a set of assessed risks, and N={1, 2, . . . , n} are indices of those risks. Also, TA={ta_1, ta_2, . . . , ta_m}, which is a set of treatment actions for risks, and M={1, 2, . . . , m} are indices of treatment actions. These treatment actions are defined to mitigate risks from R. For each risk, a risk level rl is assigned (rl≥0 when risk is 0), which risk levels represent a discrete set of levels mapped to an organizational standard, e.g., not applicable, low, medium, high, exceptional as shown, for example, in Table 1 below. These levels can be represented as a set of numbers, e.g., 0,1,2,3,4, etc. or an organization-specific value or amount (FAIR methodology, i.e., Factor Analysis of Information Risk).

At step 410, the association made between a set of defined treatment actions (TA) and risk events (R) at step 405, risk dimensions r(α\hat{ }) at step 409, and impact of ta on σ(r) at step 407 are used to provide an ITAR matrix characterization. In embodiments, ta is defined as a treatment action from TA of risk r, which is a risk from R. Also, risks usually represent a final value of multiple factors α\hat{ }, where α\hat{ }=α_1, . . . , α_k. Typical examples of such factors are probability and impact. In such cases, each risk can be considered as a function r(α\hat{ })=r(α_1, . . . , α_k), which assigns a value from the set [0, rl] to each defined probability and impact configuration. With this, it is possible to define at step 407 an operation σ of treatment action ta on risk r as:

σ(r)=r(ta(α\hat{ }))=r(ta(α_1), ta(α_2), . . . , ta(α_k)).

In aspects of the invention, the operation o may be defined by an organization, e.g., a board of small and medium-sized enterprises (SMEs) specializing in the area of assessed risks supported by historical data analysis. Such data, which typically contains historical risk assessments along with delivery (steady) state and transition state observations of risks materialization (if a risk event occurred and what was the impact) are used to (i) decide the risk assessment accuracy, (ii) update risk event occurrence probability, (iii) provide an impact of risk on delivery, and (iv) other risks dimensions if such are considered.

At step 410, a residual risk matrix (Implementing Treatment Action on Risk (ITAR)) may be defined as a matrix of numbers representing the level of improvement or mitigation of risks upon application of treatment actions with the information from steps 405, 407 and 409. This may be provided as follows:

$$ITAR = ( \begin{matrix}a\_ 11 & … & a\_ 1 n \\ … & … & … \\ a\_m1 & … & a\_mn\end{matrix} ) .$$

In embodiment, values a_ij represent the final impact of ta_i on risk r_j increasing or decreasing risk level. For example, each a_ij represents the level of risk r_j, which decreases or increases by applying treatment action ta_i. For example, by applying treatment action ta_1 on risk r_1, the final risk is decreased by 1, i.e., ITAR (1,1)=−1.

In embodiments, the whole vector α\hat{ }=α_1, . . . , α_k of k dimensions of assessed risks may be taken into consideration. An example would be k=2, where dimensions represent probability and impact for each risk. Then, α\hat{ }=(α_1, α_2)=(probability_change, impact_change). Value a_ij is retrieved from α\hat{ } based on defined mapping of probability and impact on final risk. Accordingly, ITAR is a residual risk matrix defined in the following way:

$$ITAR = ( \begin{matrix}σ ( {α}_{11}^{\hat{}} ) & … & σ ( {α}_{1 n}^{\hat{}} ) \\ … & … & … \\ σ ( {α}_{m 1}^{\hat{}} ) & … & σ ( {α}_{mn}^{\hat{}} )\end{matrix} ) .$$

At step 415, weights of risks vector (wor) and probability of implementation vector (poi) may be determined. For example, when an organization assess risk, additional dimensions may be taken under consideration. Illustratively, each risk event can be considered as potentially having a different impact on the organizational risk, so in a risk assessment, each risk can have a different impact on the final calculated risk. Such weights are defined based on historical data. This dimension can be expressed by weights of risks vector (wor), where weights are assigned to risks r_i from R in the following way:

wor=(w(r_1), w(r_2), . . . , w(r_n))

In addition, each treatment action can be considered as potentially having different probability of implementation by the organization, which may be determined by the organization based on their account policy. This dimension can be expressed by probability of implementation vector (poi) where probabilities are assigned to each treatment action ta_j from TA in the following way:

poi=(poi(ta_1), poi(ta_2), . . . , poi(ta_m))

Due to some uncertainty level included into vector wor caused by organizational knowledge gaps, it is possible to account for possible outliers. Such errors may occur and can be included into calculations due to unprecise organizational investigation about risks' weights or overwriting them due to environmental prerequisite. To solve this issue, at step 420, a factorization of R by “˜”, may be determined. More specifically, using the factorization of a set of risks is used to determine and mitigate the treatment action's impact on risk uncertainty.

For example, in aspects of the invention, additional equivalence relation “˜” on the set R can be introduced by grouping risks into categories. Such risk categories are considered as naturally existing in the set R due to risk event definitions. Typical examples of such risk event categories are financial risks, architecture control, suppliers, currency and refresh of hardware (HW)/software (SW), regulatory risks, etc. CRisk is defined as a set of these risks categories.

With this noted, it is possible to define the equivalence relation “˜” on the set R, where r_i˜r_j if and only is r_i and r_j belong to the same risk category from CRisk. R|˜| is a set of risk classes {μ_1, μ_2, . . . μ_s} defined by the equivalence relation “˜” and s=|R|˜| is a number of created classes of risks. The average of risk weight, probability and σ in each class R|˜| can be calculated as follows:

$$\vert μ\_t \vert * [ avg ( wor ( r\_i ) * poi ( ta\_j ) * σ ( {α}_{ij}^{\hat{}} ) \vert μ\_t ) ]$$

At step 425, the residual function Δ can be calculated. As noted herein, the residual function is used to create an optimal plan of improvement of risk reduction. In embodiments, as the processes described herein are iterative, the residual function may be residual function Δ for all possible scenarios. For example, in embodiments, the impact of treatment action on the final risk assessment can be defined as:

$$Δ = {\sum }_{t = 1}^{\vert R \vert ∼ \vert} \vert μ\_t \vert * [ avg ( wor ( r\_i ) * poi ( ta\_j ) * σ ( {α}_{ij}^{\hat{}} ) \vert μ\_t ) ]$$

At step 425, the residual risk assessment considers all possible scenarios of treatment action subset implementation on the risk event set. For example, let SubTA={subta_1, . . . , subta_z} be a set of subsets of treatment actions. Then, Δ(subta_x) represents the result of calculation Δ over subset subta_x, where missing treatment actions are replaced by 0 in the calculations. This approach provides a way to calculate the result of Δ when only some of treatment actions are implemented.

At step 430, a determination is made as to whether any further selections for risk mitigation are possible. If so, a set of defined treatment actions (TA) will be association with the further selections and the processes will again begin at step 405. In this way, the impact of every implemented plan may be measured and fed back into the system to learn from the plan and to minimize residual risk assessment error. In embodiments, the learning may be provided by machine learning and artificial intelligence. In embodiments, the machine learning can be supervised or unsupervised machine learning as is known in the art.

If there are no further selectins, at step 435, the processes recommend a subset of treatment action, where Δ is giving the best final risk mitigation. Moreover, at step 440, a continual service improvement process measures the impact of the created treatment action plan on the delivery. If the risk materializes in the delivery when implementing the proposed set of treatment actions, the processes will revert back to step 415. In this way, the continual service improvement processes may measure the impact of the treatment action plan and minimize the level of uncertainty and residual risk assessment error.

In this way, the processes described herein optimize treatment of risk in terms of both cost effectiveness and probability of success, while enabling lifecycle management of treatment plans, facilitating their completion and measuring their impact on service delivery. Also, the processes herein automatically create the treatment action plan based on defined treatment actions.

### Use Case

The present use case considers the scenario of assessing risk by using the processes described herein. A primary task is to provide risk assessment based on the pre-defined set of risks which need to be assessed during an engagement process.

For the purpose of this example, consider the set of risks R={r_1, r_2, . . . , r_8} and set of treatment actions TA={ta_1, ta_2, . . . , ta_147}. It should be understood by those of skill in the art that the present example is illustrative and should not be limited. For example, in a real-world risk assessment process, there can be more than approximately 100 questions and over 1,000 treatment actions. The table below uses examples from a set of questions, treatment actions, and comments from real business process, though.

By way of example, the following Table 1 lists a set of risk topics 1-8 along with levels of risk assigned to each possible answer, including N/A (not applicable), L (Low), M (Medium), H (High), E (Exceptional), with possible defined treatment actions. It should be understood by those of ordinary skill in the art that no treatment options are defined with low (L) risks; instead, the treatment options are defined below the medium (M) risks and high (H) risks. The risk topics may be defined by “R”, the treatment options (e.g., treatment actions) may be defined as ta_1, ta_2, etc. and the medium and high risks may include risks defined as r_1, r_2, etc.

TABLE 1
1. Client Requirements Definition

| | |
|---|---|
| L | Detailed information is not available but this is acceptable in this early stage of |
| | engagement |
| L | The Client requirements are documented sufficiently to develop an accurate and |
| | detailed solution and minimum change is expected. |
| M | The Client requirements are largely documented sufficiently to develop an accurate and |
| | detailed solution but a moderate level of change can be expected. |

Ensure assumptions and dependencies are documented in the response.
Ensure change control process is in place.
Ensure the proposal contains language which will allow Service Provider to
perform full and complete Due Diligence or Joint Verification allowing Service
Provider to change its transition strategy, costs and price.
Include Terms in the proposal to allow re-pricing the implementation when the
requirements and design have been completed and accepted.
If this is a Firm Price proposal, consider the proposal as a Non-Binding price.
Propose a pilot or due-diligence phase to document Client requirements and
delimit the solution scope.
Require a joint walk-through of the requirements and Service Provider's proposed
solution with the Client prior to executing contract or in the first phase of the
contract. Make sure the terms allow for re-pricing and rescheduling the project if
assumptions were incorrect.
Break the bid into separate phases or contracts beginning with a requirement
development/validation phase.

| | |
|---|---|
| M | The Client requires a very early indication of potential price. Our solution is therefore |
| | highly assumptive and designed only to demonstrate capability and price points. |

Solution needs to be able to respond to changes, including the expected duration to
stand up and establish service, as well as underpinning assumptions and
dependencies.
If price type is still not defined, or if there is not yet any agreement on T&Cs, then
the Service Provider price should be subject to contract and not open for
acceptance

| | |
|---|---|
| H | Requirements in the request for proposal were developed by a third-party with little |
| | Client involvement or understanding. |

Ensure assumptions and dependencies are documented in Service Provider's
response.
Ensure change control process is in place.
Ensure the proposal contains language which will allow Service Provider to
perform full and complete Due Diligence or Joint Verification allowing Service
Provider to change its transition strategy, costs and price.
Include Terms in the proposal to allow re-pricing the implementation when the
requirements and design have been completed and accepted.
If this is a Firm Price proposal, consider the proposal as a Non-Binding price.
Propose a pilot or due-diligence phase to document Client requirements and
delimit the solution scope.
Require a joint walk-through of the requirements and Service Provider's proposed
solution with the Client prior to executing contract or in the first phase of the
contract. Make sure the terms allow for re-pricing and rescheduling the project if
assumptions were incorrect.
Break the bid into separate phases or contracts beginning with a requirement
development/validation phase.

| | |
|---|---|
| M | The Client requirements are only partially documented or are expected to remain |
| | negotiable throughout the lifetime of the contract. |

Ensure assumptions and dependencies are documented in Service Provider's
response.
Ensure change control process is in place.
Ensure the proposal contains language which will allow Service Provider to
perform full and complete Due Diligence or Joint Verification allowing Service
Provider to change its transition strategy, costs and price. Ensure Service Provider
is able to re-validate SOW (technical scope, real workload) and adjust price
accordingly.
Agree scope with Client and define clearly Service Provider perimeter in the
statement of work (baseline, etc.)
Include Terms in the proposal to allow re-pricing the implementation when the
requirements and design have been completed and accepted.
If this is a Firm Price proposal, consider the proposal as a Non-Binding price.
Propose a pilot phase if appropriate to document Client requirements and delimit
the solution scope.
Require a joint walk-through of the requirements and Service Provider's proposed
solution with the Client prior to executing contract or in the first phase of the
contract. Make sure the terms allow for re-pricing and rescheduling the project if
assumptions were incorrect.
Break the bid into separate phases or contracts beginning with a requirement
development/validation phase.
Ensure that late changes to the contract are fully acknowledged in the Cost Case

| | |
|---|---|
| E | Requirements are to be developed as a part of this project and included as a part of a |
| | combined phase, fixed price bid (for example, Requirements plus Design and |
| | Implementation). |

Ensure change control process is in place.
Ensure the proposal contains language which will allow Service Provider to
perform full and complete Due Diligence or Joint Verification allowing Service
Provider to change its transition strategy, costs and price.
Include Terms in the proposal to allow re-pricing the implementation when the
requirements and design have been completed and accepted.
If this is a Firm Price proposal, consider the proposal as a Non-Binding price.
Propose a pilot or due-diligence phase to document Client requirements and
delimit the solution scope.
Require a joint walk-through of the requirements and Service Provider's proposed
solution with the Client prior to executing contract or in the first phase of the
contract. Make sure the terms allow for re-pricing and rescheduling the project if
assumptions were incorrect.
Break the bid into separate phases or contracts beginning with a requirement
development/validation phase.

2. In Flight Projects

| | |
|---|---|
| L | There are no in flight projects or none of any significance to be of a concern. |
| M | There are a moderate number of in flight projects and Service Provider does not have |
| | the complete knowledge of the projects, in terms of project scope and schedule. |

Establish the number and magnitude of in flight projects during Due Diligence.
Ensure that the contract gives Service Provider the right to revise pricing based on
new information, or caps the work effort in some manner.
Establish a baseline of hours or full time employee resources for in flight projects.
Ensure all in flight projects have a detailed approved statement of work or Client
equivalent.
Ensure all in flight projects have a detailed Project plan or Client equivalent, that is
used to manage the project and is current.
Ensure all in flight projects have a detailed cost budget, that is used to manage the
project and is current.
Review and confirm ETC costs and schedule and ensure costs are included in the
cost model.

| | |
|---|---|
| H | There are a high number of in flight projects and Service Provider does not have the |
| | complete knowledge of the projects, in terms of project scope, and schedule. |

Establish the number and magnitude of in flight projects during Due Diligence.
Ensure that the contract gives Service Provider the right to revise pricing based on
new information, or caps the work effort in some manner.
Establish a baseline of hours or full time employee resources for in flight projects.
Ensure all in flight projects have a detailed approved statement of work or Client
equivalent.
Ensure all in flight projects have a detailed MS Project plan or Client equivalent,
that is used to manage the project and is current.
Ensure all in flight projects have a detailed cost budget, that is used to manage the
project and is current.
Review and confirm costs and schedule and ensure costs are included in the cost
model.

3. Client Relationship/Expectations

| | |
|---|---|
| L | The client expectations are aligned to the contract objectives, requirements are well |
| | defined, understood, and agreed to in all functions of the Client's business. |
| M | The client expectations are mostly aligned to the contract objectives, however there are |
| | some issues around either requirements, solution, deliverables, etc. that need to be |
| | addressed. |

Discuss with the Client to understand the issues around their expectations versus
their requirements and suggest updates to contract objectives if deemed necessary.
Ensure a strict change control process is in place and changes are documented and
aligned with Client expectations.
Ensure that the contract objectives and Client expectations are well documented
and aligned.
Prior to contract execution, walk-through the Service Provider proposed solution
with the Client's users to ensure there are no misunderstandings.

| | |
|---|---|
| H | The client expectations are not aligned to the contract objectives, there are a number of |
| | issues around either requirements, solution, deliverables, etc. that need to be addressed. |

Discuss with the Client to understand the issues around their expectations versus
their requirements and suggest updates to contract objectives if deemed necessary.
Ensure a strict change control process is in place and changes are documented and
aligned with Client expectations.
Ensure that the contract objectives and Client expectations are well documented
and aligned.
Prior to contract execution, walk-through the Service Provider proposed solution
with the Client's users to ensure there are no misunderstandings.

| | |
|---|---|
| H | The requirements or expectations of the buyers are not aligned with those of the budget |
| | holders and/or end users |

Consider offering Change Management support for the Client's Change Program

| | |
|---|---|
| H | This is an extension or repeat Business in connection with an existing contract that has |
| | a troubled Client Relationship or a Client that is difficult to work with. |

Consider increasing the resourcing and/or banding of the Delivery Management
team.
Ensure that proposed staffing can accommodate lengthy negotiations on e.g. tax
issues, invoice payments and delay in amendment signings.

4. Client Involvement/Readiness

| | |
|---|---|
| L | Minimum or no concern exists whether the Client has skills, time or capability to meet |
| | their responsibilities. |
| M | Some concerns exist whether the Client has the skills, time or capability to meet their |
| | responsibilities. |

Highlight client responsibilities and document them fully in the statement of work.
Define a Client/Service Provider Steering committee to review and monitor risk
areas including Client readiness.
Include requirement in Proposal for Client to report status on its responsibilities to
help ensure project stays on track.
Include requirement for planned regular status reports (i.e. weekly) to be provided
that will also include status of whether or not client is meeting their
responsibilities.
Conduct a Client readiness assessment to assess the Client's capabilities.
Obtain written commitment from the Client executive to ensure that the Client
staff will be prepared to perform their responsibilities.
Offer to include billable Service Provider resources in the scope to assist the Client
in performing their responsibilities on an hourly basis.
Ensure that the time period allowed for walk-in take over r similar situation is
sufficient for adequate knowledge transfer to be completed and makes adequate
provision for the retention of key critical staff

| | |
|---|---|
| H | Significant concerns exist whether the Client has the skills, time or capability to meet |
| | their responsibilities. |

Highlight client responsibilities and document them fully in the statement of work.
Define a Client/Service Provider Steering committee to review and monitor risk
areas including Client readiness.
Include requirement in Proposal for Client to report status on its responsibilities to
help ensure project stays on track.
Include requirement for planned regular status reports (i.e. weekly) to be provided
that will also include status of whether or not client is meeting their
responsibilities.
Conduct a Client readiness assessment to assess the Client's capabilities.
Obtain written commitment from the Client executive to ensure that the Client
staff will be prepared to perform their responsibilities.
Offer to include billable Service Provider resources in the scope to assist the Client
in performing their responsibilities on an hourly basis.

5. Contract Structure

| | |
|---|---|
| N/A | Standard Service Provider terms will be used for this contract. |
| L | The contract will include slight deviations approved by Service Provider Legal. |
| M | The Client requires terms that differ from those generally acceptable to Service |
| | Provider. Terms have been approved but there are risks associated with some of them |
| | (e.g. Benchmarking, Sweep clause) |

Ensure that any non-standard terms have been assessed for additional effort and if
applicable have been included into the Cost Model.

| | |
|---|---|
| H | The Client requires terms which significantly deviate from those acceptable to Service |
| | Provider. Terms have been approved but there are significant risks associated with |
| | some of them (e.g. Client/Service Provider may develop clashing interpretations of the |
| | Contract or required Client Consents may be inadequately addressed by Contract/Cost |
| | Case/Timetable) |

Document and communicate Client roles and dependencies, agreeing them with
client.
Ensure that any non-standard terms have been assessed for additional effort and if
applicable have been included into the Cost Model.
Obtain approval to the non-standard terms from Service Provider Legal
Department, Business and Delivery if applicable.
Take exception to the onerous terms requested by the Client. Propose alternate
terms or approaches.
Preferably prior to Signature, the PE, DPE and remainder of Account Team should
review the contract for both clarity and awareness. Post-Signature their
understanding should then be jointly agreed with the Client retained organization.
Ensure that the Client dependencies schedule includes all assumptions and
responsibilities, and makes appropriate provision for Client default in this area.

6. Financials Payment Terms

| | |
|---|---|
| L | Payment terms will be consistent with standard Service Provider payment terms. No |
| | issues are expected. |
| M | The Termination clause or other contract terms do not adequately cover Service |
| | Provider for stranded costs for equipment leases, network lines, etc. |

Ensure that contract language provides for financial responsibility transfer of
stranded costs from Service Provider to Client and/or is included in the termination
charges.
Involve Service Provider Legal Department to assist in negotiating these terms.

| | |
|---|---|
| M | The Global Offering billing requires manual intervention or additional interface to the |
| | existing billing system. |

Ensure costs are included for manual intervention and / or building of interfaces to
billing systems.
Ensure that all involved Service Provider departments are adequately informed
about the billing procedure.
Ensure a test of the billing interfaces before they are used for contractual billing.

| | |
|---|---|
| H | Contract Cost Drivers are not aligned with Revenue Drivers. |

Consider limiting our exposure via safeguards such as collars and caps

| | |
|---|---|
| H | The contract contains pricing where profitability varies by tower, such that if the |
| | contract was later descoped to cancel more profitable services, Service Provider would |
| | be left with an unfavorable GP margin. |

Ensure that this situation is eliminated from the solution.
Ensure that no allocation of cost across towers is part of the cost case (avoid
subsidization).
State the overall price as a package price, with termination charges stated for each
service tower.
Include contract language which gives Service Provider the option to increase
pricing for remaining services if descoping occurs.
Ensure that there is a minimum service commitment clause included in the
contract.

| | |
|---|---|
| H | The Client is unwilling to accept an Inflation Clause in the Contract. |

Make appropriate financial provision in the Cost Case or Pricing Case

7. Ownership of Architectural Control

| | |
|---|---|
| N/A | Service Provider has complete contractual architectural control, owns the hardware and |
| | Service Provider software and is responsible for the development and deployment of |
| | the defined architecture. Client may have review, but not approval rights. |
| L | Client has architectural control, owns the hardware and software. |
| M | Client has total or partial IT architectural control of the hardware/software, but Service |
| | Provider retains control of its own offerings so associated risks relate only to |
| | integration of those offerings with Client Systems |

Include in the proposal a joint Client and Service Provider IT Hardware
architecture review board in which Service Provider has more than 50% of the
vote.
Include a clause in the contract allowing Service Provider to negotiate financial
and / or service level agreement relief if Client's architectural decisions impact
Service Provider's financial position and / or ability to deliver the services.
Ensure that the roles and responsibilities of both Service Provider and the client
are clearly defined in the contract.
Consider including a contract clause to ensure that any new tools or processes that
need to be developed by Service Provider as a result of the change of the
architecture, Service Provider can bill the project to the Client.
Consider including a contract clause to request a measurement period to confirm
achievement of any impacted service level agreement / service level objective as a
result of the change of the architecture.

| | |
|---|---|
| H | Service Provider is responsible for contractual compliance (including service levels) of |
| | hardware and Service Provider software but Client has total or partial IT architectural |
| | control |

Include in the proposal a joint Client and Service Provider IT Hardware
architecture review board in which Service Provider has more than 50% of the
vote.
Include a clause in the contract allowing Service Provider to negotiate financial
and / or SLA relief if Client's architectural decisions impact Service Provider's
financial position and / or ability to deliver the services.
Ensure that the roles and responsibilities of both Service Provider and the client
are clearly defined in the contract.
Request to have a Service Provider representative on the Architectural Control
Board.
Consider including a contract clause to ensure that any new tools or processes that
need to be developed by Service Provider as a result of the change of the
architecture, Service Provider can bill the project to the Client.
Consider including a contract clause to request a measurement period to confirm
achievement of any impacted SLA / SLO as a result of the change of the
architecture.

| | |
|---|---|
| H | Deal contains Dynamic Automation in combination with use of non-standard-tools and |
| | Client has total or partial IT architectural control. |

Consider amending the solution to remove the use of non-standard tools.
If the solution must contain non-standard tools then quantify their impact upon the
expected productivity gains.
Verify that the Client is able to accommodate the Dynamic Automation
implementation plan and will permit Dynamic Automation on all planned servers.

| | |
|---|---|
| E | Service Provider and the Client owns each their parts of the HW and SW and have joint |
| | contractual architectural control and joint responsibility for the development and |
| | deployment of the defined architecture with no specific waiver for Cloud Services. |

Include in the proposal a joint Client and Service Provider IT Hardware
architecture review board in which Service Provider has more than 50% of the
vote.
Include a clause in the contract allowing Service Provider to negotiate financial
and / or SLA relief if Client's architectural decisions impact Service Provider's
financial position and / or ability to deliver the services.
Ensure that the roles and responsibilities of both Service Provider and the client
are clearly defined in the contract.
Request to have a Service Provider representative on the Architectural Control
Board.
Consider including a contract clause to ensure that any new tools or processes that
need to be developed by Service Provider as a result of the change of the
architecture, Service Provider can bill the project to the Client.
Consider including a contract clause to request a measurement period to confirm
achievement of any impacted SLA / SLO as a result of the change of the
architecture.
Work with the Client to explain the importance of having clear and separated
architectural control with Service Provider having architectural control of the
Cloud Services.

8. Transition and Transformation Planning - Level of Detail and Achievability

| | |
|---|---|
| L | No transition / transformation (T&T) is required. |
| L | Only preliminary T&T client requirements are available, engagement is in Non-binding |
| | Price and a generic\draft T&T Plan based on Service Provider standard definitions is in |
| | place. |
| L | Detailed T&T client requirements are available and T&T Plan is sufficiently |
| | customized to convey major milestones and/or deliverables, is reasonable and |
| | achievable (adequate buffer included). |
| M | Transformation activities to achieve cost reductions are required, but there is no |
| | detailed T&T Plan to achieve them. |

Where committed cost savings depend upon a transformed environment, the
transformation activities need to be included in the T&T Plan and the
transformation costs need to be included in the cost case.
If necessary, support this by a bridge between ‘to be’ costs and current ‘as-is’ costs,
showing forecasted savings.
Add contract language that protects Service Provider from possibility of client
dependencies causing delay in transformation activities.

| | |
|---|---|
| M | Detailed T&T client requirements are available and T&T Plan is somewhat customized |
| | to convey major milestones and/or deliverables. The schedule is tight but believed to be |
| | achievable (greater than 80% confidence). |

Break up the scope to deliver part of solution within a given time frame.
Include a reasonable buffer in labor estimates and project schedule to cover
potentially anticipated problems
Consider not bidding if the fixed schedule is unreasonable.
Continue to develop the T&T schedule to a satisfactory level to improve the
confidence level of achieving.
Develop detailed task dependencies, define the critical path, and provide realistic
task length assumptions.
Explain to client why it is not in their interest to force an unreasonable &
impractical schedule. As the experts, Service Provider should tell Client that slips
in a tight schedule will cause significant problems & embarrassment for Client
sponsor.
Propose an estimated schedule that is realistic.
Take exception to the schedule requirements in the contract.
Verify the plan with the Service Provider transition and delivery team.
Model the Steady State financial impact of T&T delays that postpone steady state
billing.

| | |
|---|---|
| H | A detailed T&T schedule is not available or the schedule is tight (insufficient time is |
| | believed to be available for necessary Joint Verification, Due Diligence, or Transition |
| | activities). |

Break up the scope to deliver part of solution within a given time frame.
Include an adequate buffer in labor estimates and the project schedule for
unanticipated problems.
Consider not bidding if the fixed schedule is unreasonable.
Continue to develop the T&T schedule to a satisfactory level to improve the
confidence level of achieving.
Develop detailed task dependencies, define the critical path, and provide realistic
task length assumptions.
Explain to client why it is not in their interest to force an unreasonable &
impractical schedule. As the experts, Service Provider should tell Client that slips
in a tight schedule will cause significant problems & embarrassment for Client
sponsor.
Propose an estimated schedule that is realistic.
Take exception to the schedule requirements in the contract.
Verify the plan with the Service Provider transition and delivery team.
Model the Steady State financial impact of T&T delays that postpone steady state
billing.

| | |
|---|---|
| H | The timeline for Transition/Transformation most likely will not be met and penalties |
| | will ensue. |

Break up the scope to deliver part of solution within a given time frame.
Include an adequate buffer in labor estimates and the project schedule for
unanticipated problems.
Consider not bidding if the fixed schedule is unreasonable.
Continue to develop the T&T schedule to a satisfactory level to improve the
confidence level of achieving.
Develop detailed task dependencies, define the critical path, and provide realistic
task length assumptions.
Explain to client why it is not in their interest to force an unreasonable &
impractical schedule. As the experts, Service Provider should tell Client that slips
in a tight schedule will cause significant problems & embarrassment for Client
sponsor.
Propose an estimated schedule that is realistic.
Take exception to the schedule requirements in the contract.
Verify the plan with the Service Provider transition and delivery team.

Table 2 contains a set of risk topics along with nominated treatment actions. In the present scenario, the assessment has been simplified to include eight (8) risk topics 1-8 and six (6) different treatment action options; although other risk topics and treatment actions are contemplated herein. It should be understood by those of ordinary skill in the art that no treatment options are defined with low (L) risks; instead, the treatment options are defined below the medium (M) risks (or high (H) risks if provided.

TABLE 2
1. Client Requirements Definition

| | |
|---|---|
| M | The Client requirements are only partially documented or are expected to remain negotiable |
| | throughout the lifetime of the contract. |

Require a joint walk-through of the requirements and Service Provider's proposed solution
with the Client prior to executing contract or in the first phase of the contract. Make sure the
terms allow for re-pricing and rescheduling the project if assumptions were incorrect.

2. In Flight Projects

| | |
|---|---|
| L | There are no in flight projects or none of any significance to be of a concern. |

3. Client Relationship/Expectations

| | |
|---|---|
| M | The client expectations are mostly aligned to the contract objectives, however there are some |
| | issues around either requirements, solution, deliverables, etc. that need to be addressed. |

Ensure that the contract objectives and Client expectations are well documented and aligned.

4. Client Involvement/Readiness

| | |
|---|---|
| M | Some concerns exist whether the Client has the skills, time or capability to meet their |
| | responsibilities. |

Offer to include billable Service Provider resources in the scope to assist the Client in
performing their responsibilities on an hourly basis.

5. Contract Structure

| | |
|---|---|
| M | The Client requires terms that differ from those generally acceptable to Service Provider. Terms |
| | have been approved but there are risks associated with some of them (e.g. Benchmarking, Sweep |
| | clause) |

Ensure that any non-standard terms have been assessed for additional effort and if applicable
have been included into the Cost Model.

6. Financials Payment Terms

| | |
|---|---|
| M | The Termination clause or other contract terms do not adequately cover Service Provider for |
| | stranded costs for equipment leases, network lines, etc. |

Involve Service Provider Legal Department to assist in negotiating these terms.

7. Ownership of Architectural Control

| | |
|---|---|
| M | The Client is requesting a moderate level of penalties for missed schedule/milestone/deliverable. |

Verify the plan with the Service Provider transition and delivery team.

8. Transition and Transformation Planning - Level of Detail and Achievability

| | |
|---|---|
| L | No transition / transformation (T&T) is required. |

With the above information, the processes will define an operation o of treatment action ta on risk r in the following way:
σ(r)=max(ta(α_1), ta(α_2)), where levels 1 and 2 represent probability and impact of respective risk r.

As a risk manager evaluates the risk treatment actions, it becomes known that implementing specific treatment actions has either a positive or negative effect on the initial risk. For example, by completing a treatment action, there would be an increase in risk to another risk item (e.g., increasing a Low to a Medium would have an increase in score) or there could be a decrease in risk (e.g., decreasing a Medium to a Low would have a negative score). An ITAR Matrix can be completed based on these impacts after evaluating each risk area and treatment action.

In this example:
(i) Implementing treatment action: “Require a joint walk-through of the requirements and Service Provider's proposed solution . . . ” impacts the risk topic “Client Requirements Definition” by decreasing the risk level by one from Medium to Low, which assigns a score of −1.
(ii) Implementing treatment action: “Require a joint walk-through of the requirements and Service Provider's proposed solution . . . ” impacts the risk topic “Client Relationship/Expectations” by increasing the risk level by one from Medium to High, which assigns a score of +1.
(iii) Implementing treatment action: “Require a joint walk-through of the requirements and Service Provider's proposed solution . . . ” impacts the risk topic “Client Involvement/Readiness” by increasing the risk level by one from Medium to High, which assigns a score of +1.
(iv) Implementing treatment actions from 2nd to 5^{th} will impact only the assigned risks, and the impact is just −0.5 to indicate there is not a change in risk level, but could have potential impact on the final risk when the Delta( ) function is calculated.
(v) Implementing treatment action: “Verify the plan with the Service Provider transition and delivery team” impacts the risk topic “Ownership of Architectural Control” by decreasing the risk level by one from Medium to Low, which assigns a score of −1.
(vi) Implementing treatment action: “Verify the plan with the Service Provider transition and delivery team” impacts the risk topic “Client Involvement/Readiness” by a smaller amount and assigns a score of +0.5.
(vii) Implementing treatment action: “Verify the plan with the Service Provider transition and delivery team.” impact the risk topic “Transition and Transformation Planning—Level of Detail and Achievability” by increasing the risk level by two from Low to High, which assigns a score of +2.

An ITAR Matrix can be created which will summarize the above noted scores and which shows the relative weight of each implemented treatment action on each risk topic.

### ITAR Matrix

| | |
|---|---|
| Risk | Treatment Actions |

| Topics | 1 | 2 | 3 | 4 | 5 | 6 |
|---|---|---|---|---|---|---|
| 1 | −1 | 0 | 0 | 0 | 0 | 0 |
| 2 | 0 | 0 | 0 | 0 | 0 | 0 |
| 3 | 1 | −0.5 | 0 | 0 | 0 | 0 |
| 4 | 1 | 0 | −0.5 | 0 | 0 | 0.5 |
| 5 | 0 | 0 | 0 | −0.5 | 0 | 0 |
| 6 | 0 | 0 | 0 | 0 | −0.5 | 0 |
| 7 | 0 | 0 | 0 | 0 | 0 | −1 |
| 8 | 0 | 0 | 0 | 0 | 0 | 2 |

As should be understood by those of skill in the art, the ITAR matrix may be a result of consultation with Subject Matter Experts (SME) and business teams involved in the engagement and based on historical events using machine learning as described herein. For example, one SME might know that during account transition of a very similar engagement that the treatment action “Verify the plan with the Service Provider transition and delivery team” for risk topic “Transition and Transformation Planning—Level of Detail and Achievability” resulted in a delay to the project and resulted in numerous findings. Such insight is helpful to the development of an ITAR matrix and will help to determine that there would be a corresponding risk increase of +2 to the “The timeline for Transition/Transformation most likely will not be met” risk topic.

An approach to building ITAR matrices and developing scores is by use of a machine learning model to determine such values. This may be performed by creating a classification model to determine the best class for treatment action impacts on risk based on the historical data containing such predefined attributes as:
(i) Did the risks identified in engagement arise during T&T/Delivery?
(ii) Were the treatment actions identified during engagement adequate/appropriate?
(iii) Were there any challenges in T&T/Delivery that were not anticipated during engagement?
(iv) What were the impacts of risk or treatment action on the Delivery (along with other relevant attributes like Risk Assessment Contributors, delays caused by the findings or complexity, skilled resource availability, etc.).

In embodiments, the processes can define additional dimensions and a weight of risk vector. By way of example, each risk event can be considered as potentially having a different impact on the organizational risk, so in a risk assessment, each risk can have a different impact on the final calculated risk. In this example, the weights are defined based on historical risk assessment analyses and their impact on contract delivery.

A separate process can be used to monitor the service lifecycle, which can involve different parties such as a service delivery team, or client team. The overall approach is to determine if the risk is correctly identified during the assessment, if it materialized in the delivery, if the proposed treatment action helps to mitigate the impact of the risk on the service and what is the impact on the service. Finally, there can be a loop back to document if there are any new risks identified, if treatment actions should be updated, and determine changes to the weighting of the risk, e.g., its impact on the overall service (as shown in FIG. 4 between steps 440 and 415).

In the matrix creation process, the weight of risk vectors will be the result of machine learning modelling and statistical analysis based on collected data as noted in the above proposed attributes. This may be a separate process, as its outcome is used to determine the weight vector and also in the continuous improvement process of updating risks statements, risk levels, treatment actions and Risk Consultant assignment process (if dedicated risk specialist should be assigned to the deal risk assessment, for example). In this example, consider wor=(1, 1.2, 1, 1, 1.4, 1, 1.8, 1). This may be based on a scale of 1-5, with low risk being assessed “1” and high risk being assessed “5”.

The probability of implementation of treatment action on risk is also determined. In this example, the probability of implementing chosen actions is equal to 1 in order to simplify the calculations. In a business situation, poi is determined by the organization based on their account policy, financial agreements, and agreed schedule. This may be determined by an enterprise risk management team and service integration hub representatives. Typically, a risk management team cooperatively identifies and manages business risks and their cross-functional impacts.

In this example, a potential error mitigation equivalence relation is defined based on the risk categories built in the deal risk assessment questionnaire. For example, a set of risk classes {μ_1, μ_2, . . . μ_s} defined by the equivalence relation ˜ are presented in the below set:

{1}, {2}, {3}, {4}, {5}, (6), {7,8}.

Based on the above set, it can be concluded that risk topics 7 and 8 are in close relationship and during calculations it should be considered as a consolidated impact on the final risk. With this noted, an average of risk weight, probability, and σ in each class R|˜| is calculated as follows:

$$\vert μ\_t \vert * [ avg ( wor ( r\_i ) * poi ( ta\_j ) * σ ( {α}_{ij}^{\hat{}} ) \vert μ\_t ) ] .$$

For risks topic from 1 to 6 |μ_t|=1, the formula can by simplified to wor(r_i)*σ( [symbol] ). For risk topics 7 and 8 |μ_t|=2 such that:

$$2 * [ ( wor ( r\_ 7 ) * σ ( r\_ 7 ) + wor ( r\_ 8 ) * σ ( r\_ 8 ) ) / 2 ] .$$

It should be recognized that dividing by 2 reflects the average of risk topics 7 and 8 as they are in close relationship.

The results of the above calculations is provided in the below table 3.

TABLE 3

| Risk ID | Calculation | Result |
|---|---|---|
| 1 | −1 | −1 |
| 2 | 0 | 0 |
| 3 | 1*1 + (−0.5)*1 | −0.5 |
| 4 | 1*1 + (−0.5)*1 + 0.5*1 | 1 |
| 5 | −0.5*1.4 | −0.7 |
| 6 | −0.5 | −0.5 |
| 7 | −1*1.8 | 2*0.1 |
| 8 | 2*1 | |

In this example, 6 treatment actions were implemented and expected to mitigate the final risk. Without the residual risk function, it would be expected to decrease the final risk value by −5 according to the impact of treatment actions on its risks (which in this example can be treated as “100%”). By identifying relationships between risks and treatment actions, it is now possible to see that this final risk decrease is much lower, equal to residual function Δ=−1.5 (about 30% of expected improvement).

In this example, the risk mitigation matrix can be defined as follows:

| | TA Impact | | | |
|---|---|---|---|---|
| Calculated Risk | 0-5 (0) | 5-10 (1) | 10-15 (2) | 15-20 (3) |
| Low | Low | Low | Low | Low |
| Medium | Medium | Low | Low | Low |
| High | High | Medium | Medium | Low |
| Exceptional | Exceptional | High | High | Medium |

Based on the initial risk assessment calculations, the risk is calculated as Medium. After implementing treatment actions, originally it could have been expected that the risk will be decreased from Medium to Low according to the table above (risk mitigation level is “5” which in this example can be treated as our level “100%”). However, when taking into consideration the newly presented residual risk assessment function and calculations, the treatment actions have significant impact on the risk topics. It can then be concluded that the risk mitigation does not actually decrease the overall deal risk (applied treatment actions gives actually just −1.5 improvement what is about “30%” of expected level of mitigation). It is possible now to determine that the residual risk calculation provided a more accurate representation to remain at a Medium risk level.

### Further Examples

Risk Assessment for new customer signing: when a customer signs up for a new service, there will be an initial risk assessment to ensure that all parties understand the environment and the scope of the contract engagement. During a risk assessment, the team will determine options for risk treatments such as introducing automation or increasing staffing, as well as controls that can help remediate any current risks. This disclosure would help teams determine which risk treatment options would reduce the risk of a new contract signing.

Password complexity: security best practices lead people to develop complex passwords but quite often, they will create behaviors that reduce security overall. For example, someone might create complex 15-digit passwords, but then use an unsafe practice such as writing them down to keep them accessible. This disclosure would help teams quantify options for security teams to ensure risk reduction by incorporating password managers or other tools that can improve access controls.

Updating End of Life devices: companies put their cybersecurity at risk by having devices that are at the end of their life due to the inability to apply security patches, have known vulnerabilities, and compliance or regulatory gaps. Risk is inherent when upgrading and introducing equipment due to options with operating systems, compatibility with legacy systems, or installation of cloud applications. This disclosure helps quantify risks for companies to give them the lowest residual risk score when evaluating upgrade options.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
obtaining, by a computing device, a plurality of risk events;
mapping, by the computing device, treatment actions to each of the plurality of the risk events;
determining, by the computing device, an impact of the treatment actions on each of the plurality of the risk events;
determining, by the computing device, a probability of implementation of the treatment actions;
calculating, by the computing device, how the treatment actions affect other risk factors based on the determining steps; and
providing, by the computing device, a recommendation of optimal risk mitigation based on how the first treatment actions affect the other risk events.

2. The method of claim 1, wherein the calculating is a residual function to create an optimal plan of improvement of risk reduction.

3. The method of claim 2, wherein the residual function comprises:
Δ=Σₜ₌₁^{|R|˜|}|μ_t|*[avg(wor(r_i)*poi(ta_j)*σ( [symbol] )|μ_t)], wherein
wor is a weights risks r_i,
poi is a probability of implementation where probabilities are assigned to each treatment action ta_j,
α\hat{ } is probability of the change and impact of the change, and
μ_t is a set of risk classes.

4. The method of claim 2, further comprising determining a factorization of the risk events.

5. The method of claim 4, wherein the factorization is a set of risks to determine and mitigate an impact on risk uncertainty of a treatment action.

6. The method of claim 2, wherein the residual function comprises a residual risk assessment which considers all possible scenarios of treatment actions subsequent to an implementation on the risk events.

7. The method of claim 1, further comprising obtaining a matrix characterization based on an association between the treatment actions to each of the plurality of the risk events, an impact of treatment action on a risk factor.

8. The method of claim 7, wherein the matrix characterization includes an operation o of treatment action ta on risk r as σ(r)=max(ta(α_1), ta(α_2)), where levels 1 and 2 represent probability and impact of respective risk r.

9. The method of claim 8, wherein the treatment actions include a score comprising a positive effect or a negative effect on an initial risk which are mapped into the matrix characterization.

10. The method of claim 9, wherein the scores are developed by use of a machine learning model by creating a classification model to determine a best class for treatment action impacts on risk based on historical data containing predefined attributes.

11. The method of claim 1, further comprising iteratively repeating the mapping step, determining steps and calculating step to learn, using machine learning, how the treatment actions affect the other risk factors to further refine the recommendation of the optimal risk mitigation.

12. The method of claim 1, wherein the computing device includes software provided as a service in a cloud environment.

13. A computer program product comprising one or more computer readable storage media having program instructions collectively stored on the one or more computer readable storage media, the program instructions executable to:
obtain a set of defined treatment actions;
associate the set of defined treatment actions with a plurality of risk events;
determine weights or risks vector (wor) comprising, for each risk event, a different impact on a final risk;
determine, for each risk event, a probability of implementation of the treatment action;
determine a factorization of an additional equivalence relation on a set risks by grouping risks into risk event categories;
calculate a residual risk assessment utilizing the factorization of the additional equivalence relation, the residual risk assessment considers all possible scenarios of treatment actions subsequent to an implementation on the risk events; and
generate a recommendation of a best scenario for optimal risk mitigation based on the residual risk assessment.

14. The computer program product of claim 13, wherein the risk event categories comprise at least one of financial risks, architecture control, suppliers, currency and refresh of hardware (HW)/software (SW), or regulatory risks.

15. The computer program product of claim 13, further comprising generating a matrix characterization of the defined treatment actions with a plurality of risk events.

16. The computer program product of claim 15, wherein the matrix characterization includes an operation σ of treatment action ta on risk r as σ(r)=max(ta(α_1), ta(α_2)), where levels 1 and 2 represent probability and impact of respective risk r.

17. The computer program product of claim 16, wherein the treatment actions include a score comprising a positive effect or a negative effect on an initial risk which are mapped into the matrix characterization.

18. The computer program product of claim 17, wherein the scores are developed by use of a machine learning model by creating a classification model to determine a best class for treatment action impacts on risk based on historical data containing predefined attributes.

19. The computer program product of claim 13, wherein the residual risk assessment is calculated as:
Δ=Σₜ₌₁^{|R|˜|}|μ_t|*[avg(wor(r_i)*poi(ta_j)*σ( [symbol] )|μ_t)], wherein
wor is a weights or risks vector for each risk r_i,
poi is a probability of implementation where probabilities are assigned to each treatment action ta_j,
α\hat{ } is probability of the change and impact of the change, and
μ_t is a set of risk classes.

20. A system comprising:
a processor, a computer readable memory, one or more computer readable storage media, and program instructions collectively stored on the one or more computer readable storage media, the program instructions executable to:
obtain, by a computing device, a plurality of risk events;
map, by the computing device, treatment actions to each of the plurality of the risk events;
determine, by the computing device, an impact of the treatment actions on each of the plurality of the risk events;
determine, by the computing device, a probability of implementation of the treatment actions;
calculate, by the computing device, how a first treatment action on a first risk of the plurality of risk events affects other risk factors; and
provide, by the computing device, a recommendation of optimal risk mitigation based on how the first treatment action on the first risk of the plurality of risk events affects the other risk events.
